(19) United States
(12) Patent Application Publication
(10) Pub. No.: US 2017/0051707 A1
(43) Pub. Date: Feb. 23, 2017

(54) METHOD OF REDUCING NOX EMISSIONS FROM AN ENGINE

(71) Applicant: FORD GLOBAL TECHNOLOGIES, LLC, Dearborn, MI (US)

(72) Inventors: James WRIGHT, Wanstead (GB); Paspuleti Ashish Kumar NAIDU, Basildon (GB); Peter George BRITTLE, Romford (GB); Matthew MITCHELL, Billericay (GB)

(73) Assignee: FORD GLOBAL TECHNOLOGIES, LLC, Dearborn, MI (US)

(21) Appl. No.: 15/241,144

(22) Filed: Aug. 19, 2016

(30) Foreign Application Priority Data
Aug. 20, 2015 (GB) 1514786.1

(51) Int. Cl. F02M 26/46; F02N 11/08; F02D 11/10; F02N 11/04

(52) U.S. Cl. CPC F02M 26/46; F02N 11/04; F02N 11/08; F02D 11/106; F02M 2026/004

(57) ABSTRACT

A system and method for reducing rate of increase of NOx feedgas emissions during an acceleration event in a vehicle having an engine with exhaust gas recirculation (EGR) and an electric machine, such as an integrated starter-generator (ISG) coupled to the engine include operating the electric machine to provide an assist torque and reducing engine torque accordingly in response to predicted NOx feedgas emissions exceeding a threshold. The NOx feedgas emissions may be predicted based on an exhaust gas sensor signal or a NOx model based on engine speed, engine torque, and intake EGR ratio. The engine torque may be reduced by reducing an engine torque set point. The electric machine torque may be reduced when a driver demand torque matches the reduced engine torque set point. The electric machine may be used to charge a battery in response to the driver demand torque matching the engine torque set point.

### CROSS-REFERENCE TO RELATED APPLICATIONS

This application claims foreign priority benefits under 35 U.S.C. §119(a)-(d) to GB 1514786.1 filed Aug. 20, 2015, which is hereby incorporated by reference in its entirety.

### TECHNICAL FIELD

This disclosure relates to internal combustion engines and to a method of reducing the NOx emissions from an engine of a motor vehicle during acceleration of the vehicle.

### BACKGROUND

It is known that an internal combustion engine of a motor vehicle produces NOx emissions during vehicle acceleration manoeuvers. In the case of a vehicle having a diesel engine, a high instantaneous NOx spike can occur during acceleration which may be too high to be treated by the downstream exhaust gas aftertreatment system such as a Lean NOx Trap (LNT) or Selective Catalytic Reduction (SCR) device. Such a NOx breakthrough will have a detrimental effect on exhaust tailpipe emissions.

### SUMMARY

In one or more embodiments, a system and method for reducing NOx emissions from a diesel engine during vehicle acceleration include using an electric machine to apply torque to a drivetrain when operating the engine to supply additional torque would otherwise result in NOx emissions exceeding a threshold. The electric machine may be operated as a generator to return a battery to a state of charge (SOC) prior to operating the electric machine as a motor to apply torque to the drivetrain to reduce engine torque rate of increase and any associated NOx spike.

In one embodiment, a method of reducing the NOx produced by an engine of a motor vehicle during an acceleration event includes identifying that a torque demand from a user of the motor vehicle will produce an unacceptable level of NOx emissions from the engine and, in response to said identification, using an electric machine to apply torque to a drivetrain of the motor vehicle so that the torque demand from the user is met by a combination of the torque supplied by the electric machine and the torque supplied by the engine. The method may further include reducing an engine torque set point to compensate for the additional torque being supplied by the electric machine. Reducing the engine torque set point for the engine may result in a reduction in a rate of fuel supply to the engine. The amount of fuel supplied during the acceleration event may be less than that required to meet the torque demand if no torque is supplied by the electric machine. The reduction in the engine torque set point may result in an increase in the air/fuel ratio of the mixture combusted by the engine.

In one or more embodiments, an engine torque set point may be gradually increased following the torque demand from the driver until the engine torque set point reaches a level equal to the torque demand from the driver. The electric machine may be an integrated starter-generator drivingly connected to the engine and the torque supplied by the electric machine may be a torque assist supplied by the integrated starter-generator to the engine.

An unacceptable level of NOx emissions from the engine may be a level that exceeds an instantaneous NOx treatment capacity of a NOx aftertreatment device arranged to receive exhaust gas from the engine.

Identifying that a torque demand from a user of the motor vehicle will produce an unacceptably high level of NOx emissions from the engine may comprise measuring NOx emissions from the engine and using the NOx measurement to identify when the NOx emissions are unacceptable. Alternatively, identifying that a torque demand from a user of the motor vehicle will produce an unacceptably high level of NOx emissions from the engine may comprise using an engine out (or feedgas) NOx model to identify when the NOx emissions will be unacceptably high.

In various embodiments, a motor vehicle includes an engine, an electric machine drivingly connected to a driveline of the vehicle, an electrical energy storage device connected to the electric machine, a NOx aftertreatment device arranged to receive exhaust gas from the engine and an electronic controller arranged to control the engine and the electric machine. The electronic controller identifies that a torque demand from a user of the motor vehicle will produce an unacceptably high level of feedgas NOx emissions from the engine, the electronic controller is programmed in response to said identification, to use the electric machine to apply torque to the drivetrain of the motor vehicle so that the torque demand from the user is met by a combination of the torque supplied by the electric machine and the torque supplied by the engine.

The electronic controller may be programmed to reduce an engine torque set point to compensate for the additional torque supplied by the electric machine. Reducing the engine torque set point may result in a reduction in a rate of fuel supplied to the engine. The amount of fuel supplied during the acceleration event may be less than that required to meet the torque demand if no torque is supplied by the electric machine. The reduction in the engine torque set point may result in an increase in the air/fuel ratio of the mixture combusted by the engine. The engine torque set point may be gradually increased by the electronic controller following the torque demand from the driver until the engine torque set point reaches a level equal to the torque demand from the driver.

The electric machine may be an integrated starter-generator drivingly connected to the engine and the torque supplied by the electric machine to the driveline may be a torque assist supplied by the integrated starter-generator to the engine.

An unacceptably high level of NOx emissions from the engine may be a level of NOx emission that exceeds the instantaneous NOx treatment capacity of the NOx aftertreatment device. The vehicle may include a NOx sensor located between the engine and the NOx aftertreatment device to supply a signal indicative of NOx emissions to the electronic controller and identifying that a current torque demand from a user of the motor vehicle will produce an unacceptably high level of NOx emissions from the engine may comprise using the signal from the NOx sensor to identify when the NOx emissions are unacceptably high.

Alternatively, the electronic controller may include an engine NOx out model and identifying that a torque demand from a user of the motor vehicle will produce an unacceptably high level of NOx emissions from the engine may comprise using the engine out NOx model to identify when the NOx emissions will be unacceptably high.

The NOx aftertreatment device may be one of a lean NOx trap and a selective reduction catalyst. The engine may be a diesel engine.

### BRIEF DESCRIPTION OF THE DRAWINGS

FIG. 1 is a schematic diagram of a motor vehicle constructed in accordance with a representative embodiment;

FIG. 2 is a high level flow chart illustrating operation of a system or method for controlling an engine in accordance with a representative embodiment;

FIG. 3 is an idealized composite chart showing a prior art relationship between NOx emissions and time during a vehicle acceleration event and a relationship between NOx emissions and time during the same vehicle acceleration event when the motor vehicle is operated in accordance with one or more embodiments of this disclosure; and

FIG. 4 is an idealized composite chart showing relationships between driver demand and time, engine torque and time, electric machine torque and time, and battery state of charge and time during a period of time when an electric machine is providing torque assistance to reduce NOx emissions according to various embodiments.

### DETAILED DESCRIPTION

As required, detailed embodiments are disclosed herein; however, it is to be understood that the disclosed embodiments are merely representative and may be embodied in various and alternative forms that may not be explicitly illustrated or described. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the embodiments.

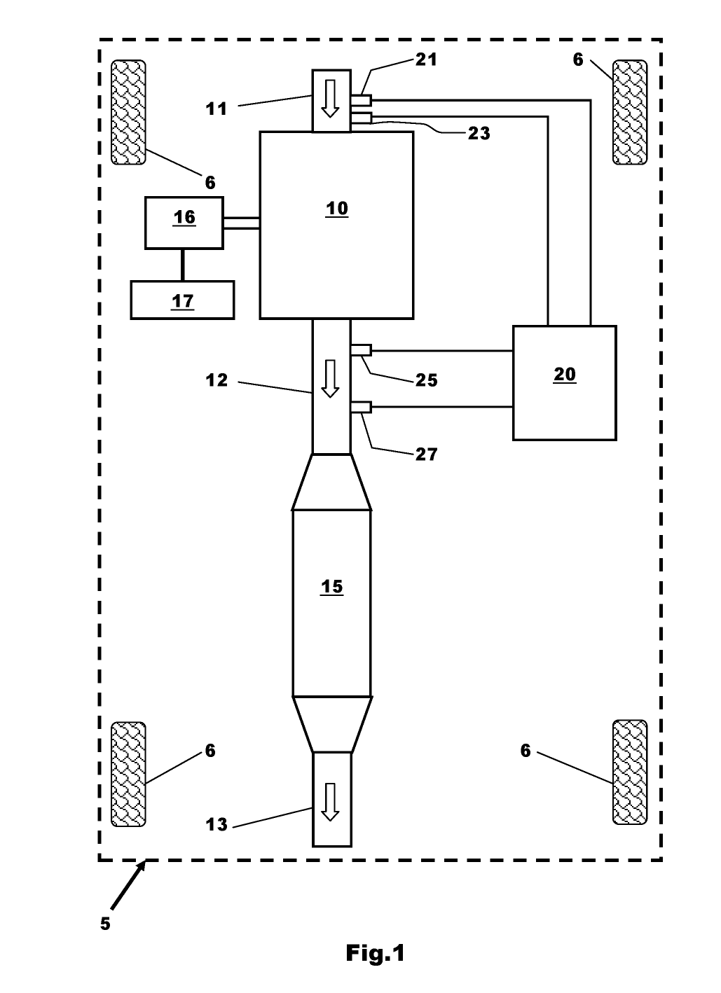

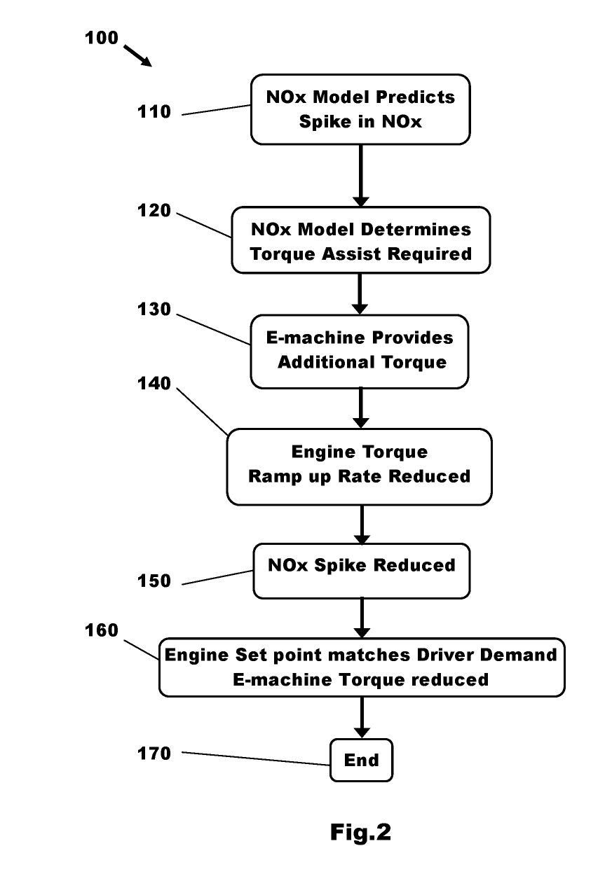

With reference to FIG. 1, a representative embodiment of a vehicle 5 having four road wheels 6, an engine 10 and an electronic controller 20. It will be appreciated that the electronic controller 20 may comprise several interconnected electronic controllers and need not be a single unit as shown in FIG. 1. Control logic, functions, algorithms, or methods performed by controller 20 may be represented by a flow chart such as illustrated in FIG. 2. This flowchart provides a representative control strategy, algorithm, and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description.

The control logic or algorithms illustrated may be implemented primarily in software executed by a microprocessor-based vehicle, engine, and/or powertrain controller, such as controller 20. Of course, the control logic may be implemented in software, hardware, or a combination of software and hardware in one or more controllers depending upon the particular application. When implemented in software, the control logic may be provided in one or more non-transitory computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

The engine 10 is arranged to receive air through an air intake 11. It will be appreciated that the flow of air can be compressed by a supercharger (not shown) or a turbocharger (not shown) in some cases before it flows into the engine 10 to improve the efficiency of the engine 10.

Exhaust gas from the engine 10 flows through a first or upstream portion 12 of an exhaust system to a NOx exhaust aftertreatment device 15 which in this case is a Lean NOx trap (LNT) but could alternatively be a Selective Catalyst Reduction Device (SCR). After passing through the LNT 15, the exhaust gas flows to atmosphere via a second or downstream portion 13 of the exhaust system.

It will be appreciated that other emission control devices or noise suppression devices may be present in the gas flow path from the engine 10 to the position where it enters the atmosphere.

An electric machine is drivingly connected to the engine 10. In the case of this example the electric machine is an integrated starter-generator 16 that can be used to generate electricity or generate torque depending upon the mode in which it is operating. A battery 17 is connected to the integrated starter-generator 16 along with associated control electronics (not shown). When the integrated starter-generator 16 is operating as a generator it charges the battery 17. The battery 17 supplies electrical energy to the integrated starter-generator 16 when the integrated starter-generator 16 is operating as a motor. The integrated starter-generator 16 is used to start the engine 10 and also in this case provides a torque assist to the engine 10 during acceleration of the vehicle 5.

The electronic controller 20 receives inputs from a number of sensors such as a mass airflow sensor 21 used to measure the mass of air flowing into the engine 10, a FMAN sensor 23, a Lambda/Oxygen sensor 25 to measure the air fuel ratio/Oxygen content of the exhaust gas exiting the engine 10 and a NOx sensor 27 to measure the level of NOx in the exhaust gas from the engine 10. The FMAN sensor 23 is used to measure the Lambda of the intake air that is to say the mix of fresh air and exhaust gas recirculation (EGR) going into the engine 10. It will be appreciated that instead of measuring ‘FMAN’ it can be modelled using exhaust Lambda and the EGR rate. Stated differently, FMAN represents the proportion of exhaust gas in the engine intake. EGR rate is a measure of a fraction of the mixture entering the engine recirculated from the exhaust. FMAN may be corrected for the proportion of the exhaust gas that contains oxygen such that FMAN is the fraction of combusted gases in the intake mixture. Exhaust gases may refer to the total exhaust gas and combusted gases may refer to the exhaust gas less the oxygen. FMAN may be used to represent the composition of the intake gas.

The electronic controller 20 is operable to control the operation of the engine 10 and the operating state of the integrated starter-generator 16. It will be appreciated that the electronic controller 20 could be formed of several separate electronic units electrically connected together and need not be in the form of a single unit as shown in FIG. 1. The electronic controller 20 is programmed or arranged to reduce NOx emissions from the engine 10 when the vehicle 5 is accelerating.

When the signals received by the electronic controller 20 from the sensors monitoring the engine 10 and the exhaust gas emissions from the engine 10 indicate that the amount of NOx in the exhaust gas exiting the LNT 15 is rising rapidly, due to a sudden torque demand (T) required to meet a request for acceleration of the vehicle 5 from a driver of the vehicle, the electronic controller 20 is arranged to use the integrated starter-generator 16 to supply a torque assist (Tₐ) to the engine 10 by operating it as a motor. This additional torque (Tₐ) supplied by the integrated starter-generator 16 would normally result in an increase in the acceleration of the engine 10, however, in the case of this invention, the engine torque set point for the engine 10 is reduced at the same time by the electronic controller 20.

The electronic controller 20 is programmed to meet the torque demand (T) from the driver by combining the output torque (Tₑ) from the engine 10 with the torque assist Tₐ provided by the integrated starter-generator 16 as requested by the driver.

That is to say:

−T=Tₑ+Tₐ

Therefore the torque Tₑ required to be produced by the engine 10 can be reduced by the amount of assist torque Tₐ provided by the integrated starter-generator 16. In order to achieve this reduction in torque from the engine 10, the amount of fuel supplied to the engine 10 is reduced so that the air/fuel ratio (Lambda) will be increased. This will result in a reduction in the NOx emissions from the engine 10 thereby reducing or eliminating the risk that the quantity of NOx being produced will overload the downstream LNT 15 or SCR if an SCR is used instead of an LNT.

The amount of torque assist is gradually reduced and the engine torque is ramped up at a slower rate to meet the driver demand until there is no longer any requirement for torque assist and the torque set point for the engine 10 matches the driver demand.

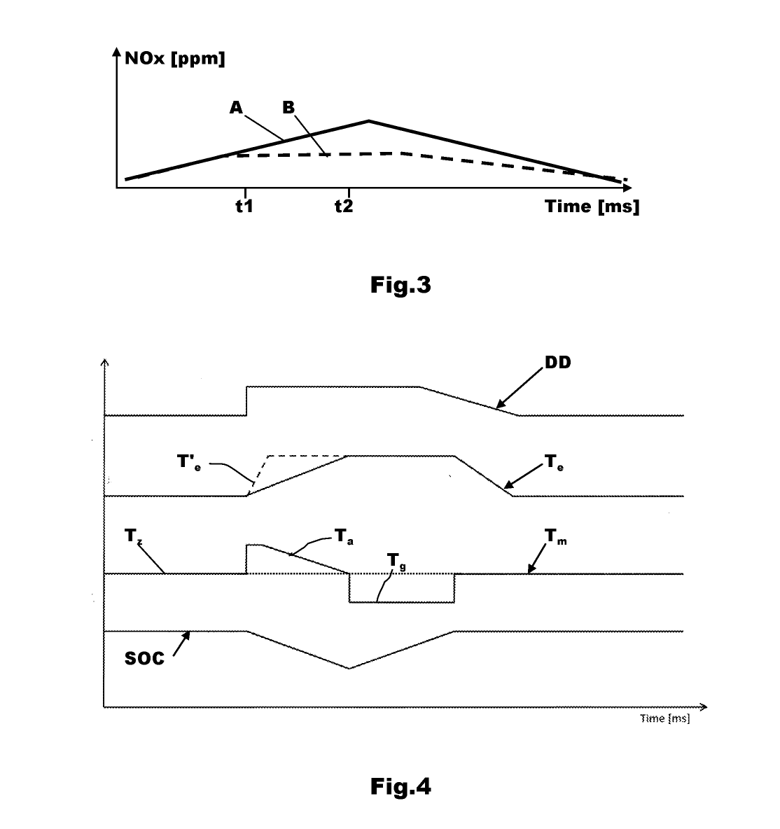

FIG. 3 shows an idealized form of the relationship between NOx and time for an acceleration event. The line ‘A’ represents the relationship if no electric machine torque assist is supplied. The line ‘B’ represents the relationship if torque assist is supplied in accordance with embodiments of this disclosure.

It can be seen that the use of torque assist greatly reduces the peak NOx produced by the engine 10 thereby preventing excess NOx from being produced during an acceleration event. It will also be appreciated that an additional benefit of this torque assist approach is that, because the amount of fuel supplied to the engine 10 is reduced, the overall fuel economy of the vehicle 5 will be increased.

Various embodiments have been described with reference to an apparatus arranged to use an actual measurement of NOx produced by a NOx sensor 27 to determine when to use torque assist to reduce NOx emissions from the engine 10. With reference to FIG. 2, a flowchart illustrating operation of a system or method 100 which in many respects is the same as that previously described but in which, instead of using a direct measurement of NOx produced by the engine to control the application of electric machine torque assist, a NOx out prediction model is used to predict when a spike in instantaneous NOx will be produced.

The NOx out prediction model is used in the case of this example by the controller 20 to control the application of torque assist from the integrated starter-generator 16 to prevent the spike from occurring. The use of a NOx out prediction model has the advantage of overcoming the delay that can occur if actual NOx sensor measurements are used. This delay is due to the fact that the NOx has to rise before the NOx sensor 27 can provide an indication of this to the electronic controller 20. If a NOx out prediction model is used the conditions likely to produce a NOx spike can be used to predict the occurrence of the NOx spike before it has actually happened thereby providing additional time to switch the integrated starter-generator 16 into a motor mode. A NOx out prediction model typically relates the level of NOx produced by an engine to a function of engine speed, engine torque and intake Lambda (representing excess air or oxygen content of the intake).

That is to say:

−NOx Level=f(n, TQ, fman)

where: n=engine speed; TQ=engine torque; and fman=intake Lambda.

The method starts in box 110 where the NOx model predicts that a NOx spike is likely to occur. The method then advances to box 120 where the reduction in engine torque required from that requested to prevent the amount of NOx produced by the engine 10 from exceeding the maximum NOx absorption rate of the LNT 15 is determined.

It will be appreciated that the invention is not limited to use with a NOx aftertreatment device and could be used to reduce a spike in NOx emissions from any engine irrespective of whether it has a NOx aftertreatment device or not. Therefore the reduction in engine torque from that requested reduces or prevents a NOx spike.

That is to say, when an unacceptably high level of NOx emissions from the engine is predicted, a NOx spike, a level that, in the case of an engine fitted with a NOx aftertreatment device, will exceed the instantaneous NOx treatment capacity of the NOx aftertreatment device arranged to receive exhaust gas from the engine thereby resulting in NOx breakthrough, additional torque is requested from the electric machine to prevent or greatly reduce this NOx breakthrough.

In a case where no NOx aftertreatment device is present, an unacceptably high level of NOx emissions from the engine is a level of NOx emission that exceeds a predefined NOx output level.

The difference between the actual torque demand (T) from a driver of the vehicle 5 and the engine torque (Tₑ) required to prevent NOx breakthrough is then calculated to provide a driver torque [(T−Tₑ)=(Tₐ)] for an integrated starter-generator controller.

Then in box 130 the integrated starter-generator 16 is switched to a motor mode to apply the required torque assist and in box 140 the engine torque ramp up rate is reduced to a rate required to prevent the NOx breakthrough. The amount of torque assist is set by the integrated starter-generator controller which in this case forms part of the electronic controller 20 but could be a separate controller.

The result, as indicated in box 150 is that the NOx spike is reduced to a level where it will either not produce NOx breakthrough if a NOx aftertreatment device is fitted or to a level lower than it would otherwise be in the case of an engine not having a NOx aftertreatment device.

From box 150 the method advances to box 160 where the torque assist is reduced and the engine set point matches the demand of the driver.

Then in box 170 the method ends with the NOx spike being eliminated or significantly reduced.

Referring to FIG. 4, a graph illustrates an idealized form of the operation of embodiments according to the disclosure. The graph illustrates the relationships between time and driver demand (DD), engine torque (Tₑ), electric machine torque (Tₘ), and state of charge (SOC) of the battery 17 during a period of time in which a method in accordance with various embodiments of the disclosure is used to reduce a NOx spike.

It can be seen that the rate at which the engine torque Tₑ increases from a baseline level representing constant engine running is reduced compared to the rate of increase indicated by the broken line T′ₑ which is the rate at which the engine torque would increase if no electric machine torque assist were to be used. During the period of torque assist, the torque provided by the electric machine 16 rises from zero torque T_{Z} to Tₐ and then ramps down again to zero.

In the case of the example shown recharging of the battery 17 follows the use of torque assist resulting in a torque generator load T_{g} being applied to the engine 10. The use of the integrated starter-generator 16 as a generator is used to return the state of charge SOC of the battery 17 to substantially the same level it was prior to providing the torque assist. It will however be appreciated that this need not be the case and that recharging could be delayed until a time when regenerative energy capture could be used to recharge the battery 17 or minimize the fuel penalty of associated with recharging the battery 17.

In summary, the rapid rate of increase in engine output torque that would normally result from a sudden increase in torque demand will result in an inefficient fresh charge and exhaust gas recirculation mix and a consequential spike in NOx production. Using torque assist from the electric machine in accordance with embodiments described herein reduces the rate at which engine torque has to be increased and so the NOx spike is eliminated or significantly reduced.

Although the representative embodiments have been described with reference to a mild hybrid vehicle having an electric machine implemented by an integrated starter-generator, it will be appreciated that it could also be applied with benefit to other vehicles having an electric machine with sufficient torque capacity to produce the required torque assist to reduce engine output torque to prevent a NOx spike from occurring thereby prevent NOx breakthrough, or to reduce NOx production below a desired level following a request for significantly more torque from the engine.

It will be appreciated that the electric machine need not directly supply torque to the engine it is merely required that the torque assist is supplied to part of a driveline of the vehicle that has the effect of permitting the torque from the engine to be reduced. For example and without limitation, the electric machine could be an electric rear axle drive (ERAD) or a drive motor of a series hybrid vehicle. It will also be appreciated that the system and method is applicable to diesel and other internal combustion engines producing NOx.

While representative embodiments are described above, it is not intended that these embodiments describe all possible forms of the claimed subject matter. Rather, the words used in the specification are words of description rather than limitation, and it is understood that various changes may be made without departing from the spirit and scope of the disclosure. Additionally, the features of various implementing embodiments may be combined to form further embodiments that are not explicitly described or illustrated. While various embodiments may have been described as providing advantages or being preferred over other embodiments or prior art implementations with respect to one or more desired characteristics, as one of ordinary skill in the art is aware, one or more features or characteristics may be compromised to achieve desired overall system attributes, which depend on the specific application and implementation. These attributes include, but are not limited to: cost, strength, durability, life cycle cost, marketability, appearance, packaging, size, serviceability, weight, manufacturability, ease of assembly, etc. Embodiments described as less desirable than other embodiments or prior art implementations with respect to one or more characteristics are not necessarily outside the scope of the disclosure and may be desirable for particular applications

What is claimed is:

1. A vehicle comprising:
an engine having an exhaust gas recirculation (EGR) valve controllable to supply exhaust gas to an engine intake;
an emissions control device disposed in an exhaust flow downstream of the engine;
a lambda sensor disposed in the engine intake to measure an EGR ratio in the engine intake;
an electric machine connected to the engine and a battery; and
a controller communicating with the EGR valve, the sensor, and the electric machine, the controller programmed to, in response to an increased rate of requested engine torque during an acceleration event resulting in predicted NOx feedgas emissions exceeding a threshold, the NOx feedgas emissions determined by a NOx model based on engine speed, engine torque, and the EGR ratio measured by the lambda sensor, control the electric machine to provide an assist torque and correspondingly reduce the rate of increase of requested engine torque to meet a driver demand torque.

2. The vehicle of claim 1 wherein the electric machine comprises an integrated starter-generator.

3. The vehicle of claim 1 wherein the threshold is set based on NOx capacity of the emissions control device.

4. The vehicle of claim 1, the controller further programmed to reduce the assist torque provided by the electric machine in response to the engine torque meeting the driver demand torque.

5. The vehicle of claim 1, the controller programmed to reduce an engine torque set point to compensate for the assist torque being supplied by the electric machine.

6. The vehicle of claim 5, the controller programmed to reduce a rate of fuel supply to the engine to in response to reducing the engine torque set point.

7. The vehicle of claim 1 wherein the electric machine comprises an integrated starter-generator drivingly connected to the engine and wherein the assist torque is supplied directly to the engine by the integrated starter-generator.

8. A vehicle comprising:
an engine having exhaust gas recirculation (EGR);
an integrated starter-generator (ISG) coupled to the engine; and
a controller programmed to, in response to predicted NOx feedgas emissions exceeding a threshold, operate the ISG as a motor to reduce an engine torque rate of increase needed to provide a desired wheel torque, wherein the controller predicts NOx feedgas emissions using a model based on engine speed, engine torque, and intake EGR ratio.

9. The vehicle of claim 8 further comprising an intake lambda sensor in communication with the controller and configured to measure the intake EGR ratio.

10. The vehicle of claim 8 further comprising an exhaust gas sensor disposed in an exhaust from the engine, the controller further programmed to calculate the intake EGR ratio based on a signal from the exhaust gas sensor and a commanded EGR rate.

11. The vehicle of claim 8, the controller further programmed to reduce ISG torque in response to the engine torque meeting the desired wheel torque.

12. The vehicle of claim 8, the controller programmed to reduce an engine torque set point in response to the predicted NOx feedgas emissions exceeding the threshold.

13. A method for controlling a vehicle having an electric machine coupled to an engine with exhaust gas recirculation, comprising:
controlling, by a controller, the electric machine to provide torque in response to predicted NOx feedgas emissions associated with a rate of increase of engine torque to provide a driver demand torque during acceleration, and
reducing an engine torque set point by an amount corresponding to the electric machine torque to reduce actual NOx feedgas emissions.

14. The method of claim 13 further comprising calculating the predicted NOx feedgas emissions in response to a signal from an exhaust gas sensor positioned in an exhaust stream of the engine.

15. The method of claim 13 further comprising calculating the predicted NOx feedgas emissions using a NOx model based on engine speed, engine torque, and an intake ratio of exhaust gas recirculation to intake air.

16. The method of claim 15 wherein the intake ratio of exhaust gas recirculation to intake air is measured by an intake lambda sensor.

17. The method of claim 13 further comprising reducing the torque provided by the electric machine in response to the driver demand torque matching the engine torque set point.

18. The method of claim 13 further comprising providing torque from the electric machine directly to the engine.

19. The method of claim 18 wherein the electric machine comprises an integrated starter-generator.

20. The method of claim 13 further comprising operating the electric machine to charge a battery in response to the driver demand torque matching the engine torque set point.
